(19) United States
(12) Patent Application Publication
(10) Pub. No.: US 2004/0054846 A1
(43) Pub. Date: Mar. 18, 2004

(54) Backup device with flash memory drive embedded

(76) Inventors: Wen-Tsung Liu, HsinDian City (TW); Lin Tien, HsinDian City (TW)

Correspondence Address: TROXELL LAW OFFICE PLLC, SUITE 1404, 5205 LEESBURG PIKE, FALLS CHURCH, VA, 22041, US

(21) Appl. No.: 10/244,020

(22) Filed: Sep. 16, 2002

(51) Int. Cl. G06F 12/00

(52) U.S. Cl. 711/103

(57) ABSTRACT

The present invention discloses a backup device with a flash memory drive embedded, thereof, a flash memory drive is effectively integrated with a backup device with a control unit in it, which enables bidirectional data transmission between the flash memory card(s) and the backup device, in turn the data is stored in storage medias such as recordable disks (CD-R, CD-RW, DVD-RW and DVD-RAM) and/or hard disk.

### BACKGROUND OF THE INVENTION

1. Field of the Invention

The present invention relates to a backup device, more particularly to a backup device with a flash memory drive embedded, which enables bidirectional data transmission between the flash memory card(s) and the backup device, and enables to exchange and backup the data.

2. Background of the Invention

With the quick development of technologies, people demand higher and higher storage capacity for multimedia data. Thus the mainstream of portable storage media has evolved from initial available magnetic media (i.e., diskette) to optical storage media (i.e., CD) with higher storage capacity, better data preservation, and faster access speed. The devices which can backup multimedia data to the optical storage media are mainly classified into peripheral rewritable device depending on computer and independent backup devices (backup systems).

A backup device of the present invention belongs to an independent backup device. A conventional independent backup device usually comprises an access disk unit and a read-write disk unit, wherein the read-write disk unit can record and back up the data accessed by the access CD unit, or the backup device can be connected to a host through a signal-transmitting element to record and back up the data stored in the host.

However, for the independent backup device which is the most popular and is widely used in flash memory media (flash memory card or memory card) of consumer electronic products or devices (e.g., DC, PDA, MP3 Players), since there is not any access device corresponding or being available for flash memory card in the backup device, thus effective data exchange and backup between the flash memory card and the backup device is not available, therefore the application scope of above backup device is limited to some extent and inconvenience may occur in some cases. Therefore, the key task of the present invention is how to integrate a flash memory media with a standard backup device to enable the backup device not only to backup the data stored in the optical storage media, but also to be directly used in the flash memory card, therefore bidirectional data transmission and backup are achieved.

### SUMMARY OF THE INVENTION

Thus, purpose of the present invention is to provide a backup device with a flash memory drive embedded, thereof, a flash memory drive is effectively integrated with a backup device which can not only backup the data stored in standard CD, but also enables bidirectional data transmission between the flash memory card(s) and the backup device, and also enables backup, therefore the application scope is expanded, and convenience is achieved.

The structure, appliance principle, and function of the present invention will be completely understood with specific reference to the following description of drawings:

### DESCRIPTION OF THE DRAWINGS

FIG. 1 is the block diagram of the circuit according to the present invention.

FIG. 2 is the block diagram of the operation according to the present invention.

1 backup Device

10 control Unit

11 controller

12 operation Unit

121 Displaying Unit

122 operation keyset

13 memory Unit

131 program-storing memory

132 flash memory

14 O/I interface

15 disk read-write unit

2 flash memory drive

21 conversion interface

### DESCRIPTION OF THE PREFERRED EMBODIMENT

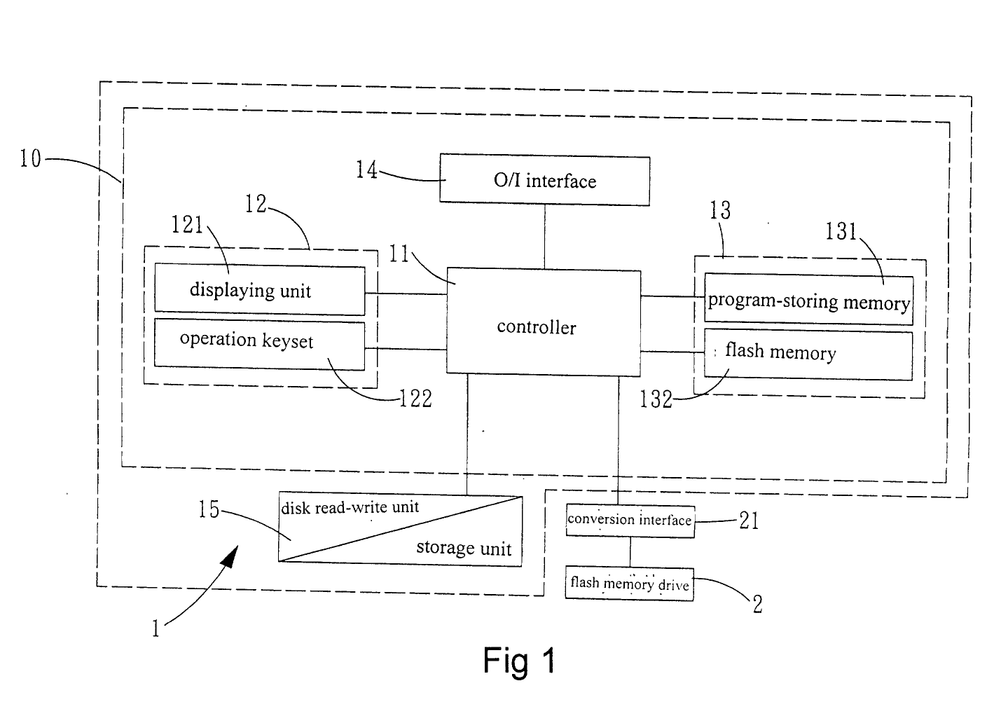

Referring to FIG. 1, the present invention mainly comprises a backup device 1 and a flash memory drive 2;

Wherein there are a controller 11, an operation unit 12, and a control unit 10 comprising at least one memory unit 13 and at least an O/I interface 14 inside the backup device 1; The controller 11 is connected to a disk read-write unit 15 which enables CD to embed, and under the instructions issued from the operation unit 12, the controller 11 executes corresponding access actions or backup actions to access the data stored in the CD or the memory card(s) or to back up the data onto the CD;

The operation unit 12 comprises a displaying unit 121 on the backup device 1 and an operation keyset 122, and the operation unit 12 is connected to said controller 11 to control the access or backup data stored in the CD or the memory card(s) according to indication on the displaying unit 121 with the help of the operation keyset 122;

The memory unit 13 is connected to the controller 11 and it comprises a program-storing 131 and a flash memory 132 to access program or multimedia data. The O/I interface 14 can be an IDE, USB or 1394 or other standard transmission interface with connecting port supporting fast data transmission, and the O/I interface 14 is connected to the controller 11 and is mounted on the backup device 1, and the O/I interface is designed to connect the backup device 1 serially to the host or customer electronic product through a predetermined signal-connecting element to transmit data between them;

Said flash memory drive 2 supports insertion of more than one memory card (CF card, SM card, SD card, MS card, MCC card or other flash memory cards storing multimedia data), and the flash memory drive 2 is integrated in the backup device 1 through a conversion interface 21 and is connected to the controller 11 to transmit signal to the backup device 1 and back up the data stored in the memory card(s) onto the recordable disks, and data stored in the CD can also be transmitted to the memory card(s); Said components together compose a backup device with a flash memory drive embedded.

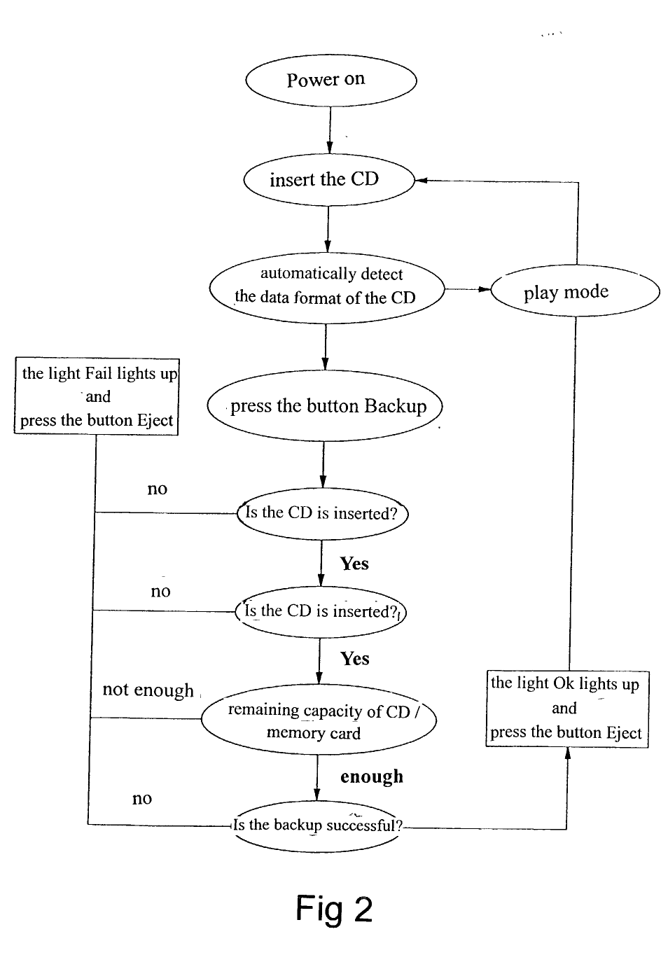

When a user wants to back up the data stored in the memory card(s) onto CD (FIG. 2), a CD will be placed in the disk read-write unit 15, and the control unit 12 will then detect the type of data format of the CD and enter play mode to play it if a multimedia format is detected; On the contrary, if the CD inserted is a blank one, the operation unit 12 will enter the backup mode, and the memory card is inserted into the flash memory drive 2, and the operation unit 12 controls the controller 11 and the memory unit 13 to back up the data stored in the memory card onto the recordable disk.

In addition, the disk read-write unit 15 of backup device according to the present invention can be designed as a separately-replacing structure, which can be replaced by separately-replacing storage units (e.g., hard disk or other storage media) each other, thus the data stored in the memory card(s) can be backed up onto the separately-replacing storage unit.

On the whole a backup device with a flash memory drive embedded according to the present invention can really attain the expected efficacy and aims in design, and it is innovative and in essence differ from conventional inventions. Thus the inventor applies for a new patent for it.

A preferred embodiment of the present invention is described as above, and this will not limit the invention. Any amendment implemented according to the present invention will be in the scope of the claims.

What is claimed is:

1. A backup device with a flash memory drive embedded, which comprises a backup device and a flash memory drive, wherein a disk read-write unit and a control unit that can directly access and backup being inside the backup unit, said flash memory drive being in said backup device and enabling more than one flash memory card to insert, said flash memory drive being connected to said control unit through a conversion interface, being effectively integrated to the backup device, to enable data stored in the memory card to be backup onto the CD and enable data of the CD to be transmitted and stored in the memory card.

2. A backup device with a flash memory drive embedded of claim 1, wherein said control unit comprises a controller.

3. A backup device with a flash memory drive embedded of claim 1, wherein said control unit comprises an operation unit.

4. A backup device with a flash memory drive embedded of claim 3, wherein said operation unit comprises an operation keyset and a displaying unit mounted on said backup device.

5. A backup device with a flash memory drive embedded of claim 1, wherein said control unit comprises a memory unit comprising a program-storing memory for storing the program or multimedia data and a flash memory.

6. A backup device with a flash memory drive embedded of claim 1, wherein said control unit comprises an O/I interface.

7. A backup device with a flash memory drive embedded of claim 6, wherein said O/I interface can be an IDE, USB or 1394 or other standard transmission interface with connecting port supporting fast data transmission.

8. A backup device with a flash memory drive embedded of claim 6, wherein said O/I interface is designed to connect the backup device 1 serially to the host or customer electronic product through a predetermined signal-connecting element to transmit data between them.

9. A backup device with a flash memory drive embedded of claim 1, wherein said disk read-write unit can be designed as a separately-replacing structure which can be replaced by separately-replacing storage units (e.g., hard disk or other storage media) each other, thus the data stored in the memory card(s) being backup onto the separately-replacing storage unit.
